(19) United States
(12) Patent Application Publication
(10) Pub. No.: US 2015/0079471 A1
(43) Pub. Date: Mar. 19, 2015

(54) LITHIUM-ION BATTERY POSITIVE ELECTRODE MATERIAL AND PREPARATION METHOD THEREOF

(71) Applicants: Ningde Amperex Technology Limited, Ningde (CN); Dongguan Amperex Technology Limited, Dongguan (CN)

(72) Inventors: Xiangpeng FANG, Ningde (CN); Jin CHONG, Ningde (CN); Quan KUANG, Ningde (CN); Na LIU, Ningde (CN)

(21) Appl. No.: 14/460,229

(22) Filed: Aug. 14, 2014

(30) Foreign Application Priority Data
Sep. 16, 2013 (CN) 201310419912.8

(51) Int. Cl. H01M 4/36; H01M 4/04; H01M 10/0525; C01G 53/00; H01M 4/525; H01M 4/505

(52) U.S. Cl. CPC H01M 4/366; H01M 4/525; H01M 4/505; H01M 10/0525; C01G 53/50; H01M 4/0416; H01M 2004/028
USPC 429/219; 429/223; 429/222; 429/221; 429/220; 427/126.4; 427/126.5; 427/126.3; 427/126.1; 427/58; 427/123; 427/122

(57) ABSTRACT

The present disclosure provides a lithium-ion battery positive electrode material and a preparation method thereof. In the lithium-ion battery positive electrode material, a secondary particle comprises lithium-containing multi-element transition metal oxide primary particles and a second phase material, a second phase material forms a second phase material layer distributed on a surface of the primary particle and forms a diffusion layer together with the lithium-containing multi-element transition metal oxide by means of atoms mutual diffusion to make the second phase material layer combined with the primary particle during formation of the secondary particle from the primary particles, thereby effectively suppressing chalking of the secondary particle along boundary among the primary particles, and effectively controlling size of the primary particles and the secondary particles, and improving specific capacity, cycling performance and safety performance of a lithium-ion battery to which the lithium-ion battery positive electrode material is applied.

### CROSS-REFERENCE TO RELATED APPLICATIONS

The present application claims priority to Chinese patent application No. 201310419912.8, filed on Sep. 16, 2013, which is incorporated herein by reference in its entirety.

### FIELD OF THE PRESENT DISCLOSURE

The present disclosure relates to a field of preparing a lithium-ion battery material, and more specifically to a lithium-ion battery positive electrode material and a preparation method thereof.

### BACKGROUND OF THE PRESENT DISCLOSURE

In layered lithium-containing transition metal oxide materials, most LiCoO₂ materials are composed of primary particles; but for lithium-containing multi-element transition metal oxide materials, since in most cases a precursor of corresponding hydroxide or carbonate synthesized by a co-precipitation method is adopted, followed by mixing the precursor with an easily decomposing lithium salt and t high-temperature sintering, the lithium-containing multi-element transition metal oxide material synthesized by such a method is generally composed of larger secondary particles agglomerated by smaller primary particles, so that the secondary particles easily tend to chalk along boundary among the primary particles after high-pressure compact and long-term electrochemical cycling, thereby making an electrical contact within the positive electrode material get worse, an internal resistance become larger, thereby making the capacity of the battery prematurely deteriorated. Furthermore, the lithium-containing multi-element transition metal oxide material also has serious safety problem, that is, the deintercalated lithium-containing multi-element transition metal oxide material easily tends to decompose and release O₂ under high temperature, thereby making a fire even explosion and the like.

In order to solve the above problems, JPH11329504A and EP2571083A1 respectively disclose a positive material whose primary particles are covered by acetylene black or carbon fiber, so that the acetylene black or fiber carbon fills cracks when a secondary particle cracks, so the positive electrode material can maintain good electrical conductivity and cycle performance is not too poor. However, the acetylene black or fiber carbon covering on the surface of the primary particles merely fills among the primary particles, and cannot inhibit the chalking of the secondary particles effectively, it can only reduce the contact internal resistance after chalking of the secondary particle, since the interactions between the acetylene black or fiber carbon and the primary particle are small.

### SUMMARY OF THE PRESENT DISCLOSURE

In view of the problems existing in the background technology, an object of the present disclosure is to provide a lithium-ion battery positive electrode material and a preparation method thereof, which can effectively inhibit chalking of a secondary particle of a lithium-ion battery positive electrode material along boundary among the primary particles.

Another object of the present disclosure is to provide a lithium-ion battery positive electrode material and a preparation method thereof, which can effectively control sizes of a primary particle and a secondary particle.

Another more object of the present disclosure is to provide a lithium-ion battery positive electrode material and a preparation method thereof, which can make the lithium-ion battery have a higher specific capacity, excellent cycle performance and safety performance when applied to a lithium-ion battery.

In order to achieve the above-mentioned objects, in a first aspect, the present disclosure provides a lithium-ion battery positive electrode material, a secondary particle of the lithium-ion battery positive electrode material comprises lithium-containing multi-element transition metal oxide primary particles and a second phase material, a formula of the lithium-containing multi-element transition metal oxide is Li_{1+ε}NiₓCo_{y}Mn_{z}M_{1-x-y-z}O_{2-γ}A_{γ}, in which −0.1<ε<0.1, 0<x, y, z<1, 1-x-y-z≧0, 0≦γ≦0.3, M is a doping cation, A is a doping anion, M is selected from at least one of Na, K, Rb, Cs, Be, Mg, Ca, Sr, Ba, Al, Ga, In, Ge, Sn, Sc, Ti, V, Cr, Mn, Fe, Co, Ni, Cu, Zn, Y, Zr, Nb, Mo, Ru, Rh, Pd, Ag, Cd, La, Ce, Pr, Nd, Sm, Eu, Gd, Tb, Dy, Ho, Er, Tm, Yb and Lu, A is selected from at least one of N, F, P, S, Cl and Se; the second phase material is selected from at least one of oxides, phosphates, sulfates, silicates of aluminum (Al), boron (B), magnesium (Mg), titanium (Ti), silicon (Si), vanadium (V), scandium (Sc), chromium (Cr), strontium (Sr), yttrium (Y), zirconium (Zr), niobium (Nb), molybdenum (Mo), ruthenium (Ru), hafnium (NO and wolfram (W); the second phase material forms a second phase material layer distributed on a surface of the lithium-containing multi-element transition metal oxide primary particle and forms a diffusion layer together with the lithium-containing multi-element transition metal oxide by means of atoms mutual diffusion to combine the second phase material layer with the lithium-containing multi-element transition metal oxide primary particles during formation of the secondary particle from the lithium-containing multi-element transition metal oxide primary particles.

In order to achieve the above-mentioned objects, in a second aspect, the present disclosure provides a preparation method of a lithium-ion battery positive electrode material.

In a first manner, a preparation method of a lithium-ion battery positive electrode material according to a second aspect of the present disclosure, for preparing the lithium-ion battery positive electrode material according to the first aspect of the present disclosure, comprises steps of: providing lithium-containing multi-element transition metal oxide primary particles; dispersing the lithium-containing multi-element transition metal oxide primary particles into a dispersing solution, then adding a second phase material or a precursor of the second phase material into the dispersing solution, to make the second phase material or the precursor of the second phase material distributed on surfaces of the lithium-containing multi-element transition metal oxide primary particles, then synthesizing a precursor of secondary particles by granulation method; sintering the precursor of the secondary particles to obtain secondary particles of the lithium-ion battery positive electrode material.

In a second manner, a preparation method of a lithium-ion battery positive electrode material according to the second aspect of the present disclosure, for preparing the lithium-ion battery positive electrode material according to the first aspect of the present disclosure, comprises steps of: providing loose secondary particles with a loose structure, the loose secondary particle is formed by agglomerating primary particles of a precursor of corresponding hydroxide or a carbonate of a lithium-containing multi-element transition metal oxide; dispersing the loose secondary particles into a dispersing solution, then adding a second phase material or a precursor of the second phase material into the dispersing solution, to make the second phase material or the precursor of the second phase material enter into a gap of the loose structure of the loose secondary particle, so that the second phase material or the precursor of the second phase material is distributed on surfaces of the primary particles of the precursor of corresponding hydroxide or carbonate of the lithium-containing multi-element transition metal oxide; then filtrating and washing the obtained loose secondary particles after the above dispersing, and performing a first sintering; then adding a lithium salt, performing a second sintering, and obtaining secondary particles of the lithium-ion battery positive electrode material.

The beneficial effects of the present disclosure are as follows:

Lithium-containing multi-element transition metal oxide primary particles are combined together by the second phase material to form the secondary particle of the lithium-ion battery positive electrode material, the second phase material which is electrochemically inactive can absorb volume change of the lithium-ion battery positive electrode material by producing a volume deformation or a lattice dislocation or the like, that is, the second phase material has a better stretchability and ductibility than the lithium-containing multi-element transition metal oxide material, therefore after applying the lithium-containing multi-element transition metal oxide material to a lithium-ion battery, the second phase material layer distributed on the surface of the primary particles can absorb deformation of the secondary particle when volume change of the secondary particle of the lithium-ion battery positive electrode material according to the present disclosure occurs under high-pressure compact or repeated expansion/contraction occurs during intercalation and deintercalation of lithium-ion, thereby preventing cracks occur in the secondary particle, and effectively suppressing chalking of the secondary particle of the lithium-ion battery positive electrode material along the boundary among the primary particles, thereby improving long-term cycle stability of the lithium-containing multi-element transition metal oxide material when the lithium-containing multi-element transition metal oxide material is applied to the lithium-ion battery.

Furthermore, the diffusion layer is formed by means of atoms mutual diffusion between the second phase material and the lithium-containing multi-element transition metal oxide so as to make the second phase material layer combined with the primary particles during formation of the secondary particle, thereby the combination between the second phase material layer and the primary particle is very tight. Moreover, during the formation of the above diffusion layer, active dangling bonds on the surface of the lithium-containing multi-element transition metal oxide material can be consumed, thereby reducing catalytic activity of the lithium-containing multi-element transition metal oxide material, and preventing side reaction of an electrolyte on the surface of the primary particle or the secondary particle when the lithium-ion battery positive electrode material is applied to the lithium-ion battery, thereby effectively improving electrochemical performances of the lithium-ion battery.

Furthermore, the second phase material layer which is distributed on and combined to the surface of the primary particles can prevent growing of corresponding particles caused by inter-fuse among individual primary particles or mutual collision, diffusion among the secondary particles during formation of the secondary particles agglomerated by the primary particles (namely during high temperature sintering), and tend to help to form particles with a higher uniformity in particle size. Such lithium-ion battery positive electrode material has a higher specific capacity consistency and dynamic performance consistency, the lithium-ion battery has a higher electrical performance consistency when such a lithium-ion battery positive electrode material is applied to the lithium-ion battery.

Furthermore, the second phase material layer and a surface modification layer on the surface of the secondary particle can modify surface of the primary particles and the secondary particle, and can prevent side reaction between the electrolyte and the lithium-containing multi-element transition metal oxide material when the lithium-ion battery positive electrode material is applied to the lithium-ion battery, and can also inhibit leaching of the transition metal ions from the lithium-containing multi-element transition metal oxide material, and can also prevent corrosion of the lithium-containing multi-element transition metal oxide material caused by acidic substance in the electrolyte, thereby improving cycle performance of the lithium-ion battery. Moreover, the second phase material on the surface of the primary particles can further prevent the problem of decomposing and releasing oxygen of the deintercalated lithium-containing multi-element transition metal oxide material in case of thermal runaway of the lithium-ion battery when the lithium-ion battery positive electrode material is applied to the lithium-ion battery, thereby greatly improving safety performance of the lithium-ion battery.

### BRIEF DESCRIPTION OF THE FIGURES

FIG. 1 is a schematic structural view of a lithium-ion battery positive electrode material according to the present disclosure;

FIG. 2 is another schematic structural view of the lithium-ion battery positive electrode material according to the present disclosure; and

FIG. 3 is a schematic structural view of a loose secondary particle according to a preparation method of the lithium-ion battery positive electrode material of the present disclosure.

### REFERENCE NUMERALS ARE REPRESENTED AS FOLLOWS

PP lithium-containing multi-element transition metal oxide primary particle
SP secondary particle of lithium-ion battery positive electrode material
ML second phase material layer
DL diffusion layer
SL surface modification layer

### DETAILED DESCRIPTION

Hereinafter, a lithium-ion battery positive electrode material and a preparation method thereof and embodiments will be described in detail.

Firstly, a lithium-ion battery positive electrode material according to a first aspect of the present disclosure will be described.

Referring to FIG. 1, a lithium-ion battery positive electrode material according to a first aspect of the present disclosure, a secondary particle SP of the lithium-ion battery positive electrode material comprises lithium-containing multi-element transition metal oxide primary particles PP and a second phase material, and a formula of the lithium-containing multi-element transition metal oxide is Li_{1-ε}NiₓCo_{y}Mn_{z}M_{1-x-y-z}O_{2-γ}A_{γ}, in which −0.1<ε<0.1, 0<x, y, z<1, 1-x-y-z≧0, 0≦γ<0.3, M is a doping cation, A is a doping anion, M is selected from at least one of Na, K, Rb, Cs, Be, Mg, Ca, Sr, Ba, Al, Ga, In, Ge, Sn, Sc, Ti, V, Cr, Mn, Fe, Co, Ni, Cu, Zn, Y, Zr, Nb, Mo, Ru, Rh, Pd, Ag, Cd, La, Ce, Pr, Nd, Sm, Eu, Gd, Tb, Dy, Ho, Er, Tm, Yb and Lu, A is selected from at least one of N, F, P, S, Cl and Se; the second phase material is selected from at least one of oxides, phosphates, sulfates, silicates of aluminum (Al), boron (B), magnesium (Mg), titanium (Ti), silicon (Si), vanadium (V), scandium (Sc), chromium (Cr), strontium (Sr), yttrium (Y), zirconium (Zr), niobium (Nb), molybdenum (Mo), ruthenium (Ru), hafnium (Nf) and wolfram (W); the second phase material forms a second phase material layer ML distributed on a surface of the lithium-containing multi-element transition metal oxide primary particle PP and forms a diffusion layer DL together with the lithium-containing multi-element transition metal oxide by means of atoms mutual diffusion to combine the second phase material layer ML with the lithium-containing multi-element transition metal oxide primary particles PP during formation of the secondary particle SP from the lithium-containing multi-element transition metal oxide primary particles PP.

The Lithium-containing multi-element transition metal oxide primary particles are combined together by the second phase material to form the secondary particle of the lithium-ion battery positive electrode material, the second phase material which is electrochemically inactive can absorb volume change of the lithium-ion battery positive electrode material by producing a volume deformation or a lattice dislocation or the like, that is, the second phase material has a better stretchability and ductibility than the lithium-containing multi-element transition metal oxide material, therefore after applying the lithium-containing multi-element transition metal oxide material to a lithium-ion battery, the second phase material layer distributed on the surface of the secondary particles can absorb deformation of the primary particle when volume change of the secondary particle of the lithium-ion battery positive electrode material according to the present disclosure occurs under high-pressure compact or repeated expansion/contraction occurs during intercalation and deintercalation of lithium-ion thereby preventing cracks occur in the secondary particles, and effectively suppressing chalking of secondary particles of the lithium-ion battery positive electrode material along a boundary of the primary particles, thereby improving the long-term cycle stability of the lithium-containing multi-element transition metal oxide material. Particularly, the second phase material can more efficiently generate the lattice deformation or dislocation when the second phase material layer has a nano-scale thickness, thereby eliminating the deformation stress of the lithium-ion battery positive electrode material, and avoiding chalking of the secondary particle along the boundary among the lithium-containing multi-element transition metal oxide primary particles.

Furthermore, the diffusion layer is formed by means of atoms mutual diffusion between the second phase material and the lithium-containing multi-element transition metal oxide so as to make the second phase material layer combined with the primary particles during the formation of the secondary particle, thereby the combination between the second phase material layer and the primary particle is very tight. The above diffusion layer is a thin layer (0.005 nm˜10 nm) and has solid-solution characteristics, and formed by means of the atoms mutual diffusion between the second phase material and the lithium-containing multi-element transition metal oxide in the high temperature sintering process. Moreover, during the formation of the above diffusion layer, active dangling bonds on the surface of the lithium-containing multi-element transition metal oxide material can be consumed, thereby reducing catalytic activity of the lithium-containing multi-element transition metal oxide material, and preventing side reaction of an electrolyte on the surface of the primary particle or the secondary particle when the lithium-ion battery positive electrode material is applied to the lithium-ion battery, thus effectively improving electrochemical performances of the lithium-ion battery.

Furthermore, the second phase material layer which is distributed on and combined to the surface of the primary particles can prevent the growing of the corresponding particles cause by inter-fuse among individual primary particles or mutual collision, diffusion between the secondary particles during formation of the secondary particles (namely during high temperature sintering) agglomerated by the primary particles, and tend to help to form particles with a higher uniformity in particle size. Such lithium-ion battery positive electrode material has a higher specific capacity consistency and dynamic performance consistency, the lithium-ion battery has a higher electrical performance consistency when such a lithium-ion battery positive electrode material is applied to the lithium-ion battery.

Furthermore, the second phase material layer and a surface modification layer (as later described) can modify surface of the primary particles and the secondary particle, and can prevent side reaction between the electrolyte and the lithium-containing multi-element transition metal oxide material when the lithium-ion battery positive electrode material is applied to the lithium-ion battery, and can also inhibit leaching of the transition metal ions from the lithium-containing multi-element transition metal oxide material, and can also prevent corrosion of the lithium-containing multi-element transition metal oxide material caused by acidic substance in the electrolyte, thereby improving cycle performance of the lithium-ion battery. Moreover, the second phase material on the surface of the primary particles can further prevent the problem of decomposing and releasing oxygen of the deintercalated lithium-containing multi-element transition metal oxide material in case of thermal runaway of the lithium-ion battery when the lithium-ion battery positive electrode material is applied to the lithium-ion battery, thereby greatly improving safety performance of the lithium-ion battery.

In the lithium-ion battery positive electrode material according to the first aspect of the present disclosure, an average particle size of the primary particle PP may be 10 nm˜5 μm, preferably 300 nm˜1200 nm.

In the lithium-ion battery positive electrode material according to the first aspect of the present disclosure, an average particle size of the secondary particle SP may be 0.5 μm˜50 μm, preferably 0.5 μm˜20 μm.

In the lithium-ion battery positive electrode material according to the first aspect of the present disclosure, a thickness of the second phase material layer ML may be 0.01 nm˜300 nm, preferably 0.02 nm˜70 nm.

In the lithium-ion battery positive electrode material according to the first aspect of the present disclosure, a thickness of the diffusion layer DL may be 0.005 nm˜10 nm, preferably 0.01 nm˜3 nm.

In the lithium-ion battery positive electrode material according to the first aspect of the present disclosure, a mass fraction of the second phase material to the entire lithium-ion battery positive electrode material may be 0.1%˜13.6%, preferably 0.1%˜3%.

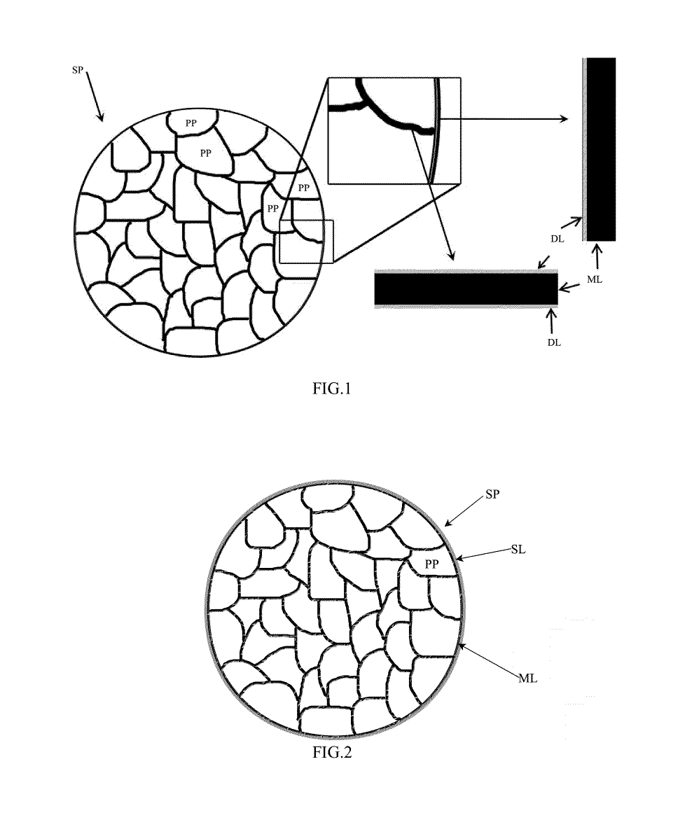

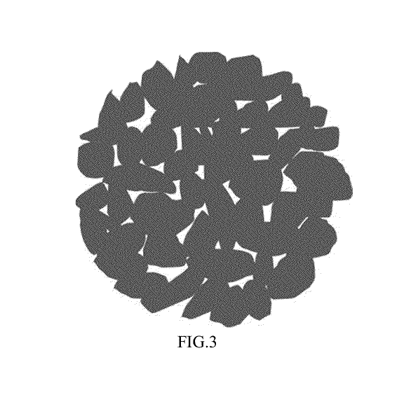

In the lithium-ion battery positive electrode material according to the first aspect of the present disclosure, referring to FIG. 2 together with FIG. 1, a surface of the secondary particle SP may further has a surface modification layer SL, a material of the surface modification layer SL may be selected from at least one of carbon, and aluminum (Al), magnesium (Mg), titanium (Ti), silicon (Si), vanadium (V), chromium (Cr), strontium (Sr), yttrium (Y), zirconium (Zr), niobium (Nb), molybdenum (Mo) and wolfram (W) and fluorides, oxides, phosphates, sulfates, silicates thereof. Specifically, the surface modification layer SL is positioned on the second phase material layer ML at the surface of the secondary particle SP.

In the lithium-ion battery positive electrode material according to the first aspect of the present disclosure, a thickness of the surface modification layer (SL) may be 5 nm˜500 nm, preferably 5 nm˜30 nm.

In the lithium-ion battery positive electrode material according to the first aspect of the present disclosure, distribution of the second phase material on the surface of the primary particles may be at least one of an uniform and continuous distribution, a discontinuous distribution and an island-like distribution.

In the lithium-ion battery positive electrode material according to the first aspect of the present disclosure, the secondary particle SP may have a solid structure or a hollow structure.

Secondly, a preparation method of a lithium-ion battery positive electrode material according to a second aspect of the present disclosure will be described.

There are two manners for a preparation method of a lithium-ion battery positive electrode material according to a second aspect of the present disclosure.

Referring to FIG. 1, in a first manner, a preparation method of a lithium-ion battery positive electrode material according to a second aspect of the present disclosure, for preparing the lithium-ion battery positive electrode material according to the first aspect of the present disclosure, comprising steps of: providing lithium-containing multi-element transition metal oxide primary particles PP; dispersing the primary particles PP into a dispersing solution, then adding a second phase material or a precursor of the second phase material into the dispersing solution, to make the second phase material or the precursor of the second phase material distributed on surfaces of the lithium-containing multi-element transition metal oxide primary particles PP, then synthesizing a precursor of secondary particles by granulation method; sintering the precursor of the secondary particles sintered to obtain secondary particle SP of the lithium-ion battery positive electrode material.

In the first manner, providing lithium-containing multi-element transition metal oxide primary particles PP may be implemented by any one of a sol-gel method, a combustion method, a solvothermal method, a vapor deposition method, a micro emulsion method or a Pechini method.

In the first manner, the granulation method may be a spray drying granulation method or a centrifugal granulation method.

In the first manner, the precursor of the second phase material may be obtained by a precipitation method or a hydrolysis method.

In the first manner, the sintering may be a once-sintering or a multiple-sintering, preferably a twice-sintering. When the once-sintering is adopted, a temperature of the sintering may range 600° C.˜1200° C. When the twice-sintering is adopted, a temperature of the first sintering may range 600˜950° C., a temperature of the second sintering may range 600˜1000° C.

In the first manner, referring to FIG. 1 and FIG. 2, the preparation method of a lithium-ion battery positive electrode material according to the second aspect of the present disclosure may further comprise a step of: forming a surface modification layer SL on a surface of the secondary particle SP. Forming the surface modification layer SL on the surface of the secondary particle SP may be implemented by any one of a precipitation method, a molten salt method, a hydrolysis method, a ball milling method, a vapor deposition method, a pulsed laser deposition method, an atom layer deposition method, an electrostatic spinning method, a solvothermal method, a sol-gel method, and an emulsion method.

In a second manner, referring to FIG. 1 and FIG. 3, a preparation method of a lithium-ion battery positive electrode material according to the second aspect of the present disclosure, for preparing the lithium-ion battery positive electrode material according to the first aspect of the present disclosure, comprises steps of: providing loose secondary particles with a loose structure, the loose secondary particle is formed by agglomerating primary particles of a precursor of corresponding hydroxide or carbonate of a lithium-containing multi-element transition metal oxide; dispersing the loose secondary particles into a dispersing solution, then adding a second phase material or a precursor of the second phase material into the dispersing solution to make the second phase material or the precursor of the second phase material enter into a gap of the loose structure of the loose secondary particle, so that the second phase material or the precursor of the second phase material is distributed on surfaces of the primary particles of the precursor of corresponding hydroxide or carbonate of the lithium-containing multi-element transition metal oxide; then filtrating and washing the obtained loose secondary particles after the above dispersing, and performing a first sintering; then adding a lithium salt, performing a second sintering, and obtaining secondary particles SP of the lithium-ion battery positive electrode material.

In the second manner, providing loose secondary particles with a loose structure may be implemented by a co-precipitation method.

In the second manner, the precursor of the second phase material may be obtained by a precipitation method or a hydrolysis method.

In the second manner, a temperature of the first sintering may range 400˜900° C., preferably 700˜750° C.

In the second manner, the lithium salt may be selected from at least one of Li₂CO₃, LiOH, LiNO₃ and LiF.

In the second manner, a temperature of the second sintering may range 600˜1200° C., preferably 800˜1000° C.

In the second manner, referring to FIG. 1 and FIG. 2, a preparation method of a lithium-ion battery positive electrode material according to a second aspect of the present disclosure may further comprise a step of: forming a surface modification layer SL on a surface of the secondary particle SP. Forming the surface modification layer SL on the surface of the secondary particle SP may be implemented by any one of a precipitation method, a molten salt method, a hydrolysis method, a ball milling method, a vapor deposition method, a pulsed laser deposition method, an atom layer deposition method, an electrostatic spinning method, a solvothermal method, a sol-gel method, an emulsion method.

Next, examples and comparative examples of the lithium-ion battery positive electrode material and the preparation method thereof according to the present disclosure will be described.

### Example 1

The lithium-containing multi-element transition metal oxide of example 1 was Li_{0.98}Ni_{1/3}Co_{1/3}Mn_{1/3}O₂, the second phase material was TiO₂.

Step a: firstly, primary particles of Li_{0.98}Ni_{1/3}Co_{1/3}Mn_{1/3}O₂ were synthesized with a sol-gel method: CH₃COOLi, Ni(CH₃COO)₂, Co(CH₃COO)₂, Mn(CH₃COO)₂ according to an atomic ratio of Li:Ni:Co:Mn=1.03:0.33:0.33:0.33 were dissolved in deionized water to form a mixed solution with a 1 mol/L total concentration, then citric acid was added and the concentration of the citric acid was 1 mol/L in the mixed solution, the obtained solution was placed into a water bath of 85° C. to evaporate water and form a gel, then the gel was transferred to an oven of 160° C. and maintained for 5 hours to form a brownish black substance, the brownish black substance was grounded into powder, and sintered in an air atmosphere of 650° C. for 2 hours to form particles with an average particle size of 300 nm.

Step b: the primary particles obtained after the above sintering were dispersed into an absolute ethanol according to a ratio of 500 g/L, 50 g tetrabutyl titanate was slowly dropped and stirred during dropping. Then it was stirred for 4 hours in an air atmosphere to sufficiently implement hydrolysis and adsorption to form a mixing solution. Then the above mixing solution was processed by a granulation method with a spray drier to form a precursor of secondary particles.

Step c: the precursor of the secondary particles was performed a once-sintering in an air atmosphere of 900° C. for 5 hours, Li_{0.98}Ni_{1/3}Co_{1/3}Mn_{1/3}O₂/TiO₂ as a lithium-ion battery positive electrode material was obtained.

### Example 2

The lithium-containing multi-element transition metal oxide of example 2 was Li_{0.98}Ni_{1/3}Co_{1/3}Mn_{1/3}O₂, the second phase material was MgO.

Step a: firstly, loose secondary particles were synthesized with a co-precipitation method: NiSO₄, CoSO₄, MnSO₄ according to an atomic ratio of Ni:Co:Mn=0.33:0.33:0.33 were dissolved in deionized water to form a mixed solution with a 1 mol/L total concentration, then a configured 1 mol/L NaOH solution was added into the above mixed solution and stirred during adding, the temperature was controlled at 75° C., loose secondary particles with loose structure were formed after sufficient reaction, namely the loose secondary particle was formed by agglomerating irregular primary particles of hydroxide precursor of Li_{0.98}Ni_{1/3}Co_{1/3}Mn_{1/3}O₂ with an average particle size of 600 nm, bigger gaps were presented among the primary particles of the hydroxide precursor of Li_{0.98}Ni_{1/3}Co_{1/3}Mn_{1/3}O₂, the average particle size of the loose secondary particles was 12 μm.

Step b: 500 g loose secondary particles were dispersed into 1 L deionized water, then 0.1 mol/L MgSO₄ solution were slowly dropped to form a mixing solution, a NaOH solution was used to adjust the mixing solution to make pH=11, the reactants was filtrated after reacting for 10 hours, the obtained precipitate was conducted a multi-element washing with deionized water and ethanol.

Step c: the washed precipitate was performed a first sintering in an air atmosphere of 500° C. for 5 hours.

Step d: the precipitate was taken out and mixed with LiOH.H₂O according to a specific ratio, a second sintering was performed in an air atmosphere of 900° C. for 10 hours after mixed evenly, Li_{0.98}Ni_{1/3}Co_{1/3}Mn_{1/3}O₂/MgO as a lithium-ion battery positive electrode material was obtained.

### Example 3

The lithium-containing multi-element transition metal oxide of example 3 was Li_{0.98}Ni_{1/3}Co_{1/3}Mn_{1/3}O₂, the second phase material was Mg₃(PO₄)₂.

Step a: firstly, loose secondary particles were synthesized with a co-precipitation method: NiSO₄, CoSO₄, MnSO₄ according to an atomic ratio of Ni:Co:Mn=0.33:0.33:0.33 were dissolved in deionized water to form a mixed solution with 1 mol/L total concentration, then a configured 1 mol/L NaOH solution was added into the above solution and stirred during adding, the temperature was controlled at 75° C., loose secondary particles with loose structure were formed after sufficient reaction, namely the loose secondary particle was formed agglomerating primary particles of hydroxide precursor of Li_{0.98}Ni_{1/3}Co_{1/3}Mn_{1/3}O₂ with an average particle size of 600 nm, bigger gaps were presented among the primary particles of the hydroxide precursor of Li_{0.98}Ni_{1/3}Co_{1/3}Mn_{1/3}O₂, the average particle size of the loose secondary particles was 12 μm.

Step b: 500 g loose secondary particles were dispersed into 1 L deionized water, then 0.15 mol/L MgSO₄ solution and 0.1 mol/L (NH₄)₂HPO₄ solution were slowly dropped and stirred during dropping to form a mixing solution, a NH₄H₂O solution was used to adjust the mixing solution to make pH=7, the reactant was filtrated after reacting for 10 hours, the obtained reactant was performed a multi-element washing with deionized water and ethanol.

Step c: the washed precipitate was performed a first sintering in an air atmosphere of 750° C. for 5 hours.

Step d: the precipitate was taken out and mixed with LiOH.H₂O according to a specific ratio, a second sintering was performed in an air atmosphere of 950° C. for 10 hours after mixed evenly, Li_{0.98}Ni_{1/3}Co_{1/3}Mn_{1/3}O₂/Mg₃(PO₄)₂ as the lithium-ion battery positive electrode material was obtained.

Step e: the above positive electrode material was dispersed into deionized water, Al(NO₃)₃ and NaOH solution were slowly dropped to form Al(OH)₃ precipitate on a surface of the secondary particle of the positive electrode material, a NaOH solution was used to adjust pH=11, the reactant was filtrated after reacting for 4 hours, the obtained precipitate was performed a multi-element washing with deionized water and ethanol, then sintered in an air atmosphere of 900° C. for 5 hours, Li_{0.98}Ni_{1/3}Co_{1/3}Mn_{1/3}O₂/Mg₃(PO₄)₂ covered with a Al₂O₃ layer (namely the surface modification layer) on a surface thereof as a lithium-ion battery positive electrode material was obtained.

### Example 4

The lithium-containing multi-element transition metal oxide of example 4 was Li_{0.98}Ni_{0.32}Co_{0.31}Mn_{0.31}V_{0.06}O_{1.95}F_{0.05}, the second phase material was TiO₂.

Step a: firstly, primary particles of Li_{0.98}Ni_{0.32}Co_{0.31}Mn_{0.31}V_{0.06}O_{1.95}F_{0.05} were synthesized with a sol-gel method: CH₃COOLi, NH4F, Ni(CH₃COO)₂, Co(CH₃COO)₂, Mn(CH₃COO)₂, H₄NO₃V according to an atomic ratio of Li:Ni:Co:Mn:V:F=1.05:0.32:0.31:0.31:0.06:0.05 were dissolved in deionized water in a PTFE container to form a mixed solution with 1 mol/L total concentration, then citric acid was added and the concentration of the citric acid was 1 mol/L in the mixed solution, the obtained solution was placed into a water bath of 85° C., to evaporate water and form a gel, then the gel was transferred to an oven of 160° C. and maintained for 5 hours to form a brownish black substance, the brownish black substance was grounded into powder, and sintered in an air atmosphere of 650° C. for 2 hours to form particles with an average particle size of 400 nm.

Step b: the primary particles obtained after the above sintering were dispersed into an absolute ethanol according to a ratio of 500 g/L, 50 g tetrabutyl titanate was slowly dropped, stood for 4 hours in an air atmosphere to sufficiently implement hydrolysis and adsorption to form a mixing solution. Then the above mixing solution was processed by granulation method with a spray drier to form a precursor of secondary particles.

Step c: the precursors of the secondary particles were dispersed into deionized water, Al(NO₃)₃ and NaOH solution were slowly dropped to form a Al(OH)₃ precipitate on a surface of precursor of the secondary particle, a NaOH solution was used to adjust pH=11, the reactant was filtrated after reacting for 4 hours, the obtained precipitate was performed a multi-element washing with deionized water and ethanol. Then a first sintering was performed in an air atmosphere of 800° C. for 3 hours and a second sintering was performed in an air atmosphere of 900° C. for 5 hours, Li_{0.98}Ni_{1/3}Co_{1/3}Mn_{1/3}O₂/TiO₂ covered with a Al₂O₃ layer (namely the surface modification layer) on a surface thereof as a lithium-ion battery positive electrode material was obtained.

### Comparative Example 1

The lithium-containing multi-element transition metal oxide of comparative example 1 was Li_{0.98}Ni_{1/3}Co_{1/3}Mn_{1/3}O₂.

Firstly, hydroxide precursor was synthesized with a co-precipitation method: a NiSO₄, CoSO₄, MnSO₄ according to an atomic ratio of Ni:Co:Mn=0.33:0.33:0.33 were dissolved in deionized water to form a mixed solution with 1 mol/L total concentration, then a prepared 1 mol/L NaOH solution was added into the above solution and stirred during adding, the temperature was controlled at 75° C., the reactant was filtrated after a sufficient reaction, the obtained precipitate was performed a multi-element washing with deionized water and ethanol. The washed precipitate was sintered in an air atmosphere of 500° C. for 5 hours, taken out and mixed evenly with LiOH.H₂O according to a ratio and was sintered in an air atmosphere of 900° C. for 10 hours, Li_{0.98}Ni_{1/3}Co_{1/3}Mn_{1/3}O₂ as the lithium-ion battery positive electrode material was obtained.

### Comparative Example 2

The lithium-containing multi-element transition metal oxide of comparative example 2 was Li_{0.98}Ni_{1/3}Co_{1/3}Mn_{1/3}O₂.

Step a: firstly, primary particles of Li_{0.98}Ni_{1/3}Co_{1/3}Mn_{1/3}O₂ were synthesized with a sol-gel method: CH₃COOLi, Ni(CH₃COO)₂, Co(CH₃COO)₂, Mn(CH₃COO)₂ according to an atomic ratio of Li:Ni:Co:Mn=1.05:0.33:0.33:0.33 were dissolved in deionized water to form a mixed solution with 1 mol/L total concentration, then citric acid was added and the concentration of the citric acid was 1 mol/L in the mixed solution, the obtained solution was placed into a water bath of 85° C. to evaporate water and form a gel, then the gel was transferred to an oven of 160° C. and maintained for 5 hours to form a brownish black substance, the brownish black substance was grounded into powder, and sintered in an air atmosphere of 650° C. for 2 hours to form particles with an average particle size of 400 nm.

Step b: the primary particles obtained after the above sintering were dispersed into an absolute ethanol according to a ratio of 500 g/L to form a mixing solution; then the above mixing solution was processed by a granulation method with a spray drier to form a precursor of secondary particles.

Step c: the precursors of the secondary particles were sintered in an air atmosphere of 900° C. for 5 hours, Li_{0.98}Ni_{1/3}Co_{1/3}Mn_{1/3}O₂ as a lithium-ion battery positive electrode material was obtained.

Finally soft package lithium-ion batteries were made by using the lithium-ion battery positive electrode materials of examples 1-4 and comparative examples 1-2. The specific process was as follows: a positive electrode active material using any of the lithium-ion battery positive electrode materials of examples 1-4 and comparative examples 1-2, together with a conductive agent conductive using carbon black, an adhesive using PVDF according to a mass ratio of 90:6:4 were mixed and dispersed into N-methylpyrrolidone (NMP) to form a slurry, which was followed by stirring, coating, drying, rolling, slitting, a positive electrode plate was obtained; a negative electrode active material using artificial graphite, together with a conductive agent using conductive carbon black, an adhesive using PVDF according to a mass ratio of 90:5:5 were mixed and dispersed into N-methylpyrrolidone (NMP) to form a slurry, which was followed by stirring, coating, drying, rolling, slitting, a negative electrode plate was obtained; the positive electrode plate, the negative electrode plate and a PE separator were wound, which were followed by welding terminals, packaging with an aluminum foil, injecting electrolyte (wherein the concentration of lithium salt was 1 mol/L LiPF₆, the solvent was EC/DMC/DEC, the volume ratio was EC:DMC:DEC=1:1:1), sealing and formation, degassing and shaping, a soft package lithium-ion battery was obtained, a discharging cut-off voltage was 2.8V, a charging cut-off voltage was 4.45V, a designed capacity of the lithium-ion battery was 2500 mAh.

Hereinafter testing processes of the lithium-ion battery positive electrode materials and the concerning soft package lithium-ion batteries prepared based on examples 1-4 and comparative examples 1-2 were presented:

Testing of related particle sizes of the lithium-ion battery positive electrode material: the particle sizes of the secondary particles of the material were analyzed by a laser particle size analyzer, the particle sizes of the primary particles were statistically analyzed by a scanning electron microscopy and a transmission electron microscopy.

Testing of related thicknesses of the lithium-ion battery positive electrode material: a section of the secondary particle of the lithium-ion battery positive electrode material was obtained by cutting the secondary particle through ion beam etching method, then the related thicknesses (the thickness of the second phase material layer ML, the thickness of the diffusion layer DL, the thickness of the surface modification layer SL) were statistically analyzed by a scanning electron microscopy and a transmission electron microscopy.

Testing of related mass ratio of the lithium-ion battery positive electrode material: the related mass ratio of the material was analyzed with an inductively coupled plasma atomic emission spectrometry method.

Cycle performance of the lithium-ion battery: at 25° C., charged to 4.45V at a constant current of 0.5 C(=1225 mA), then charged to 0.05 C(=123 mA) at a constant voltage of 4.45V, then discharged to 2.8V at a constant current of 0.5 C(=1225 mA), charged and discharged for 1000 cycles in such way, then measured the discharging capacity of the 1^{st} cycle and the discharging capacity of the 1000^{th} cycle to calculate capacity retention ratio after cycling.

The capacity retention ratio after cycling=(the discharging capacity of the 1000^{th} cycle)/(the discharging capacity of the 1^{st} cycle)×100%.

High temperature storage performance of the lithium-ion battery: at 25° C., charged to 4.45V at a constant current of 0.5 C(=1225 mA), then charged to 0.05 C(=123 mA) at a constant voltage of 4.45V, measured the thickness of the lithium-ion battery before storing. Then the above fully charged lithium-ion battery was stored in an oven of 60° C. for 30 days, and the thickness of the lithium-ion battery after storage was measured at 30^{th} day, so a swelling ratio of the lithium-ion battery after storage was calculated by a comparison of the thickness of the lithium-ion battery before storage and the thickness after storage.

The swelling ratio of the lithium-ion battery after storage=(the thickness of the lithium-ion battery after storage −the thickness of the lithium-ion battery before storage)/(the thickness of the lithium-ion battery before storage)×100%

The related parameters and testing results of the examples 1-4 and comparative examples 1-2 were shown in Table 1.

It can be seen from Table 1, the charging/discharging cycle performance at 2.8V˜4.45V of the lithium-ion battery, which applied the positive electrode material comprising the lithium-containing multi-element transition metal oxide and the second phase material according to the present disclosure, had been greatly improved. By comparing the examples 1-4 with the comparative examples 1-2, it can be found that, the capacity retention ratios of the lithium-ion batteries of examples 1-4 were much higher than the capacity retention ratios of the lithium-ion batteries of comparative examples 1-2 after 1000 cycles. It can be shown that the cycle performance at high voltage of 4.45V of the lithium-ion battery had been greatly improved when applying the lithium-ion battery positive electrode material where the second phase material was added into the lithium-containing multi-element transition metal oxide. This was because the second phase material had prevented the positive electrode material from chalking along the boundary among the primary particles due to the volume change before and after intercalation/deintercalation of lithium-ion of the positive electrode material, thereby improving the long-term cycle stability of the lithium-ion battery made by the positive electrode material.

Furthermore, it can be seen from Table 1, the high temperature storage performance at 4.45V of the lithium-ion battery, which was made by using the positive electrode material comprising the lithium-containing multi-element transition metal oxide and the second phase material according to the present disclosure, had been greatly improved. By comparing examples 1-4 with comparative examples 1-2, it can be found that, the swelling ratios of the thicknesses of the lithium-ion batteries of examples 1-4, which were charged to 4.45V and followed by a 60° C./30 days storage, were much lower than that of examples 1-2 after 1000 cycles. It was shown that the high temperature storage performance of the lithium-ion battery at high voltage of 4.45V had been greatly improved when the second phase material was added into the lithium-containing multi-element transition metal oxide. This was because the second phase material further had a function of covering material, thereby preventing the side reaction of the electrolyte on surfaces of the secondary particles and improving the life of the lithium-ion battery more effectively.

TABLE 1
Parameters and testing results of examples 1-4 and comparative examples 1-2

| | Lithium-ion battery positive electrode material | | | | | |
|---|---|---|---|---|---|---|
| | | | Average | Average | | |
| | | Second | particle | particle | | |
| | Lithium-containing multi-element | phase | size | size | Thickness | Thickness |
| | transition metal oxide | material | of PP | of SP | of ML | of DL |
| Example 1 | Li_{0.98}Ni_{1/3}Co_{1/3}Mn_{1/3}O₂ | TiO₂ | 300 nm | 10 μm | 12 nm | 1.2 nm |
| Example 2 | Li_{0.98}Ni_{1/3}Co_{1/3}Mn_{1/3}O₂ | MgO | 550 nm | 10.5 μm | 15 nm | 0.5 nm |
| Example 3 | Li_{0.98}Ni_{1/3}Co_{1/3}Mn_{1/3}O₂ | Mg₃(PO₄)₂ | 550 nm | 10.6 μm | 12 nm | 0.7 nm |
| Example 4 | Li_{0.98}Ni_{0.32}Co_{0.31}Mn_{0.31}V_{0.06}O_{1.95}F_{0.05} | TiO₂ | 400 nm | 13 μm | 13 nm | 0.6 nm |
| Comparative | Li_{0.98}Ni_{1/3}Co_{1/3}Mn_{1/3}O₂ | \ | 500 nm | 10 μm | \ | \ |
| example 1 | | | | | | |
| Comparative | Li_{0.98}Ni_{0.5}Co_{0.2}Mn_{0.3}O₂ | \ | 450 nm | 13 μm | \ | \ |
| example 2 | | | | | | |
| | | Lithium-ion battery positive electrode material | | | | |
| | | Mass fraction | | | | |
| | | of second | | | Performances of lithium- | |
| | | phase | | | ion battery | |
| | | material to | | | Capacity | Swelling |
| | | entire lithium- | | | retention | ratio of the |
| | | ion battery | Material | Thickness | ratio after | battery after |
| | | positive material | of SL | of SL | cycling | storage |
| | Example 1 | 0.01% | \ | \ | 85.30% | 17.20% |
| | Example 2 | 0.03% | \ | \ | 82.80% | 15.90% |
| | Example 3 | 0.06% | Al₂O₃ | 10 nm | 82.20% | 12.30% |
| | Example 4 | 0.05% | Al₂O₃ | 15 nm | 86.70% | 9.80% |
| | Comparative example 1 | \ | \ | \ | 60.90% | 40.70% |
| | Comparative example 2 | \ | \ | \ | 54.80% | 56.20% |

What is claimed is:

1. A lithium-ion battery positive electrode material, a secondary particle (SP) of the lithium-ion battery positive electrode material comprising lithium-containing multi-element transition metal oxide primary particles (PP) and a second phase material,
a formula of the lithium-containing multi-element transition metal oxide being Li_{1+ε}NiₓCo_{y}Mn_{z}M_{1-x-y-z}O_{2-γ}A_{γ}, in which −0.1<ε<0.1, 0<x, y, z<1, 1-x-y-z≧0, 0≦γ<0.3, M is a doping cation, A is a doping anion, M is selected from at least one of Na, K, Rb, Cs, Be, Mg, Ca, Sr, Ba, Al, Ga, In, Ge, Sn, Sc, Ti, V, Cr, Mn, Fe, Co, Ni, Cu, Zn, Y, Zr, Nb, Mo, Ru, Rh, Pd, Ag, Cd, La, Ce, Pr, Nd, Sm, Eu, Gd, Tb, Dy, Ho, Er, Tm, Yb and Lu, A is selected from at least one of N, F, P, S, Cl and Se,
the second phase material being selected from at least one of oxides, phosphates, sulfates, silicates of aluminum (Al), boron (B), magnesium (Mg), titanium (Ti), silicon (Si), vanadium (V), scandium (Sc), chromium (Cr), strontium (Sr), yttrium (Y), zirconium (Zr), niobium (Nb), molybdenum (Mo), ruthenium (Ru), hafnium (Nf) and wolfram (W),
the second phase material forming a second phase material layer (ML) distributed on a surface of the lithium-containing multi-element transition metal oxide primary particle (PP) and forming a diffusion layer (DL) together with the lithium-containing multi-element transition metal oxide by means of atoms mutual diffusion to combine the second phase material layer (ML) with the lithium-containing multi-element transition metal oxide primary particle (PP) during formation of the secondary particle (SP) from the lithium-containing multi-element transition metal oxide primary particles (PP).

2. The lithium-ion battery positive electrode material according to claim 1, wherein an average particle size of the lithium-containing multi-element transition metal oxide primary particle (PP) is 10 nm˜5 μm.

3. The lithium-ion battery positive electrode material according to claim 2, wherein the average particle size of the lithium-containing multi-element transition metal oxide primary particle (PP) is 300 nm˜1200 nm.

4. The lithium-ion battery positive electrode material according to claim 1, wherein an average particle size of the secondary particle (SP) is 0.5 μm˜50 μm.

5. The lithium-ion battery positive electrode material according to claim 4, wherein the average particle size of the secondary particle (SP) is 0.5 μm˜20 μm.

6. The lithium-ion battery positive electrode material according to claim 1, wherein a thickness of the second phase material layer (ML) is 0.01 nm˜300 nm.

7. The lithium-ion battery positive electrode material according to claim 6, wherein the thickness of the second phase material layer (ML) is 0.02 nm˜70 nm.

8. The lithium-ion battery positive electrode material according to claim 1, wherein a thickness of the diffusion layer (DL) is 0.005 nm˜10 nm.

9. The lithium-ion battery positive electrode material according to claim 8, wherein the thickness of the diffusion layer (DL) is 0.01 nm˜3 nm.

10. The lithium-ion battery positive electrode material according to claim 1, wherein a mass fraction of the second phase material to the entire lithium-ion battery positive electrode material is 0.1%˜13.6%.

11. The lithium-ion battery positive electrode material according to claim 10, wherein the mass fraction of the second phase material to the entire lithium-ion battery positive electrode material is 0.1%˜3%.

12. The lithium-ion battery positive electrode material according to claim 1, wherein a surface of the secondary particle (SP) further has a surface modification layer (SL), a material of the surface modification layer (SL) is selected from at least one of carbon, and aluminum (Al), magnesium (Mg), titanium (Ti), silicon (Si), vanadium (V), chromium (Cr), strontium (Sr), yttrium (Y), zirconium (Zr), niobium (Nb), molybdenum (Mo) and wolfram (W) and fluorides, oxides, phosphates, sulfates, silicates thereof.

13. The lithium-ion battery positive electrode material according to claim 12, wherein a thickness of the surface modification layer (SL) is 5 nm˜500 nm.

14. The lithium-ion battery positive electrode material according to claim 13, wherein the thickness of the surface modification layer (SL) is 5 nm˜30 nm.

15. A preparation method of a lithium-ion battery positive electrode material, for preparing a lithium-ion battery positive electrode material, comprising steps of:
providing lithium-containing multi-element transition metal oxide primary particles (PP);
dispersing the lithium-containing multi-element transition metal oxide primary particles into a dispersing solution, then adding a second phase material or a precursor of the second phase material into the dispersing solution, to make the second phase material or the precursor of the second phase material distributed on surfaces of the lithium-containing multi-element transition metal oxide primary particles (PP), then synthesizing a precursor of secondary particles by granulation method;
sintering the precursor of secondary particles to obtain secondary particles (SP) of the lithium-ion battery positive electrode material;
a formula of the lithium-containing multi-element transition metal oxide being Li_{1+ε}NiₓCo_{y}Mn_{z}M_{1-x-y-z}O_{2-γ}A_{γ}, in which −0.1<ε<0.1, 0<x, y, z<1, 1-x-y-z≧0, 0≦γ<0.3, M is a doping cation, A is a doping anion, M is selected from at least one of Na, K, Rb, Cs, Be, Mg, Ca, Sr, Ba, Al, Ga, In, Ge, Sn, Sc, Ti, V, Cr, Mn, Fe, Co, Ni, Cu, Zn, Y, Zr, Nb, Mo, Ru, Rh, Pd, Ag, Cd, La, Ce, Pr, Nd, Sm, Eu, Gd, Tb, Dy, Ho, Er, Tm, Yb and Lu, A is selected from at least one of N, F, P, S, Cl and Se,
the second phase material being selected from at least one of oxides, phosphates, sulfates, silicates of aluminum (Al), boron (B), magnesium (Mg), titanium (Ti), silicon (Si), vanadium (V), scandium (Sc), chromium (Cr), strontium (Sr), yttrium (Y), zirconium (Zr), niobium (Nb), molybdenum (Mo), ruthenium (Ru), hafnium (Nf) and wolfram (W),
the second phase material forming a second phase material layer (ML) distributed on a surface of the lithium-containing multi-element transition metal oxide primary particle (PP) and forming a diffusion layer (DL) together with the lithium-containing multi-element transition metal oxide by means of atoms mutual diffusion to combine the second phase material layer (ML) with the lithium-containing multi-element transition metal oxide primary particle (PP) during formation of the secondary particle (SP) from the lithium-containing multi-element transition metal oxide primary particles (PP).

16. The preparation method of the lithium-ion battery positive electrode material according to claim 15, wherein further comprising a step of: forming a surface modification layer (SL) on a surface of the secondary particle (SP).

17. The preparation method of lithium-ion battery positive electrode material according to claim 16, wherein a material of the surface modification layer (SL) is selected from at least one of carbon, and aluminum (Al), magnesium (Mg), titanium (Ti), silicon (Si), vanadium (V), chromium (Cr), strontium (Sr), yttrium (Y), zirconium (Zr), niobium (Nb), molybdenum (Mo) and wolfram (W) and fluorides, oxides, phosphates, sulfates, silicates thereof.

18. A preparation method of a lithium-ion battery positive electrode material, for preparing a lithium-ion battery positive electrode material, comprising steps of:
providing loose secondary particles with a loose structure, the loose secondary particle being formed by agglomerating primary particles of a precursor of corresponding hydroxide or carbonate of a lithium-containing multi-element transition metal oxide;
dispersing the loose secondary particles into a dispersing solution, then adding a second phase material or a precursor of the second phase material into the dispersing solution, to make the second phase material or the precursor of the second phase material enter into a gap of the loose structure of the loose secondary particle, so that the second phase material or the precursor of the second phase material is distributed on surfaces of the primary particles of the precursor of corresponding hydroxide or carbonate of the lithium-containing multi-element transition metal oxide;
then filtrating and washing the obtained loose secondary particles after the above dispersing, and performing a first sintering;
then adding a lithium salt, performing a second sintering, and obtaining secondary particles (SP) of the lithium-ion battery positive electrode material;
a formula of the lithium-containing multi-element transition metal oxide being Li_{1+ε}NiₓCo_{y}Mn_{z}M_{1-x-y-z}O_{2-γ}O_{2-γ}A_{γ}, in which −0.1<ε<0.1, 0<x, y, z<1, 1-x-y-z≧0, 0≦γ<0.3, M is a doping cation, A is a doping anion, M is selected from at least one of Na, K, Rb, Cs, Be, Mg, Ca, Sr, Ba, Al, Ga, In, Ge, Sn, Sc, Ti, V, Cr, Mn, Fe, Co, Ni, Cu, Zn, Y, Zr, Nb, Mo, Ru, Rh, Pd, Ag, Cd, La, Ce, Pr, Nd, Sm, Eu, Gd, Tb, Dy, Ho, Er, Tm, Yb and Lu, A is selected from at least one of N, F, P, S, Cl and Se,
the second phase material being selected from at least one of oxides, phosphates, sulfates, silicates of aluminum (Al), boron (B), magnesium (Mg), titanium (Ti), silicon (Si), vanadium (V), scandium (Sc), chromium (Cr), strontium (Sr), yttrium (Y), zirconium (Zr), niobium (Nb), molybdenum (Mo), ruthenium (Ru), hafnium (Nf) and wolfram (W),
the second phase material forming a second phase material layer (ML) distributed on a surface of the lithium-containing multi-element transition metal oxide primary particle (PP) and forming a diffusion layer (DL) together with the lithium-containing multi-element transition metal oxide by means of atoms mutual diffusion to combine the second phase material layer (ML) with the lithium-containing multi-element transition metal oxide primary particle (PP) during formation of the secondary particle (SP) from the lithium-containing multi-element transition metal oxide primary particles (PP).

19. The preparation method of the lithium-ion battery positive electrode material according to claim 18, wherein further comprising a step of: forming a surface modification layer (SL) on a surface of the secondary particle (SP).

20. The preparation method of lithium-ion battery positive electrode material according to claim 19, wherein a material of the surface modification layer (SL) is selected from at least one of carbon, and aluminum (Al), magnesium (Mg), titanium (Ti), silicon (Si), vanadium (V), chromium (Cr), strontium (Sr), yttrium (Y), zirconium (Zr), niobium (Nb), molybdenum (Mo) and wolfram (W) and fluorides, oxides, phosphates, sulfates, silicates thereof.
